(19) United States
(12) Patent Application Publication
(10) Pub. No.: US 2006/0000410 A1
(43) Pub. Date: Jan. 5, 2006

(54) Curtain coater

(76) Inventors: Jukka P. Koskinen, Jarvenpaa (FI); Timo Nurmlainen, Jarvenpaa (FI)

Correspondence Address: STIENNON & STIENNON, 612 W. MAIN ST., SUITE 201, P.O. BOX 1667, MADISON, WI, 53701-1667, US

(21) Appl. No.: 11/131,531

(22) Filed: May 18, 2005

(30) Foreign Application Priority Data
Jul. 2, 2004 (FI) U20040268

(51) Int. Cl. B05B 17/00; B05C 11/02; B05D 1/40

(52) U.S. Cl. 118/303; 118/123; 427/331

(57) ABSTRACT

A multilayer curtain coater for coating a moving material web, such as a paper or board web, with coating material, in which an application device is arranged above a material web having an upper surface, the web being mounted for motion with respect to the curtain coater, and the web arranged so that a coating material feeds onto the surface of the web in a curtain-like flow. The curtain coater has a scraper with a scraper surface which engages the upper surface of the web to remove an air boundary layer thereon. The durability of the scraper surface is increased by constructing the scraper out of a hard wear resistant material or material which is surface-hardened or provided with a durability-enhancing coating layer.

### CROSS REFERENCES TO RELATED APPLICATIONS

This application claims priority on Finnish App. No. FI U20040268, filed Jul. 2, 2004, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention is a curtain coater for coating a moving material web with a treatment material. The treatment material in this type of curtain coater is fed through an application device onto the surface of the material web in a curtain-like flow. In the curtain coater of this invention, coating material flows freely as a falling curtain onto the surface of the moving web. The curtain coater has an application bar arranged above the web, and has a narrow nozzle slit or a slanting feed plane covering the width of the web, from which the coating material is fed onto the surface of the web as a uniform curtain which covers the width of the web. The web, which moves at a speed which is a multiple of the speed of the curtain of downward flowing coating material, reduces the curtain of coating material into a thin film at the point of impact, thereby forming a final coating material layer on the surface of the web. The curtain coater enables many successive coating material layers to be fed simultaneously onto the web, if the application bar is provided with parallel nozzle slits through which the coating material flows or is fed onto a slanting feed plane in such a way that the coating material streams being fed through the separate nozzles are superimposed on one another before flowing onto the web.

The surface of the material web to be coated entrains a layer of air, which is carried along with the web toward the point of impact of the coating mixture curtain on the web. The air boundary layer hinders the application of coating material of the web, which is why it is removed by suitable means for removing an air boundary layer before the point of impact of the curtain of coating material on the web. Typically, means for removing an air boundary layer comprise a suction surface arranged against the web, whereby the air layer in the material web is sucked off, and an air doctor placed against the web, see for example U.S. Pat. No. 6,743,478 to Kiiha et al. issued Jun. 1, 2004, which is incorporated by reference herein. The air doctor has a curved surface or revolving scraper rod, which is placed in contact with the web. Between the moving material web and the scraper, there is usually a thin layer of air, whose thickness is typically below 500 μm. However, intermittently the scraper surface is in contact with the web, whereby friction of the web quickly wears down the scraper surface. The scraper surface is therefore provided with steel edges, which may damage the web, so that the scraper surface must be replaced.

### SUMMARY OF THE INVENTION

The multilayer curtain coater on this invention is of the type for coating a moving material web, such as a paper or board web, with coating material, in which an application device is arranged above a material web having an upper surface, the web mounted for motion with respect to a curtain coater, the web being arranged so that a coating material feeds onto the surface of the web in a curtain-like flow. The curtain coater has a scraper having a lower scraper surface engaged with the web upper surface so as to remove an air boundary layer on the surface of the web. The durability of the lower scraper surface is increased by constructing the scraper out of a hard wear resistant material or by a material which is surface-hardened or which is provided with a durability-enhancing coating layer.

The object of the present invention is to bring about a solution that will reduce the deterioration of the scraper surface of a curtain coater scraper.

The invention is based on the scraper part which is to be placed against the web being surface-hardened, coated with a wear-resistant material layer, or being constructed of a wear resistant material.

The invention achieves substantial advantages because deterioration of the scraper surface contacting the web is reduced, thus extending the life of the scraper. Since wear-resistant materials generally are expensive, it is more advantageous to coat or surface-harden the scraper surface than to prepare the whole component of the same material. Moreover, the materials of the scraper surface and the scraper body part and their properties may be chosen according to the intended purpose.

### BRIEF DESCRIPTION OF THE DRAWINGS

FIG. 1 is a schematic view of a curtain coater according to the invention.

FIG. 2 is a schematic view of a second embodiment of the curtain coater of the invention.

FIG. 3 is a schematic view of a third embodiment of the curtain coater of the invention.

FIG. 4 is a schematic view of a fourth embodiment of the curtain coapter of the invention.

FIG. 5 is a schematic view of a fifth embodiment of the curtain coater of the invention.

FIG. 6 is a schematic view of a sixth embodiment of the curtain coater of the invention.

### DESCRIPTION OF THE PREFERRED EMBODIMENTS

The curtain coaters shown in the drawings are provided with means, such as guide rolls, with which the material web 7 to be coated is guided and moved forward in the coater. The direction of motion of the web 7 is indicated in the drawings by arrows 10. An application bar 8 is arranged above the web 7 in order to supply a coating mixture onto the surface of the web 7 in the form of a free-falling curtain 6. The application bar 8 is attached to the body of the coater.

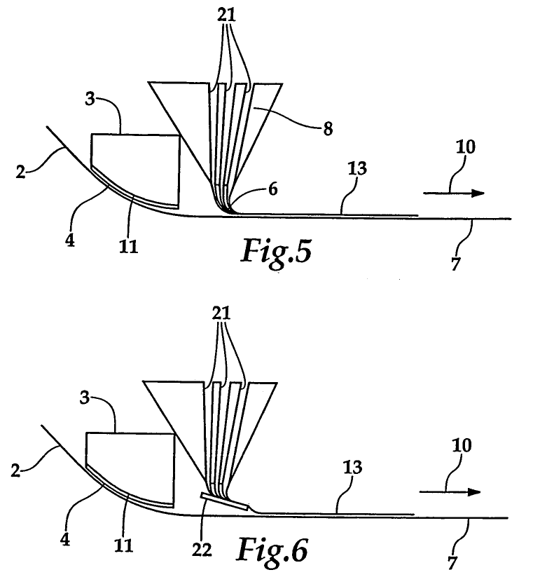

The application bar 8 has a nozzle slit 1 extending over the whole width of the web 7 through which the coating material is delivered onto the whole width of the surface of the web 7, or essentially as a free-falling curtain 6 extending over the whole width of the web. The web 7 moving at a multiple of the speed of the coating curtain 6 produced by the downward flowing coating material, reduces the coating curtain to a thin film at the point of impact, thereby forming a final coating material layer 13 on the surface of the web 7. The nozzle slit 1, may be made up of a plurality of parallel slits 21, each slit providing a different coating material so that multiple layers of coating may be simultaneously deposited on the web to form a multilayer coating, as shown in FIG. 5.

Coating material may be fed through the nozzle slit 1 onto the surface of the web 7 either directly or indirectly. Directly fed coating material flows through the nozzle slit 1 directly onto the web 7 surface in a curtain-like fashion. Indirectly fed coating material flows through the nozzle slit and onto, for instance, a slanting feed plane extending over the whole width of the nozzle slit, and then downward along the feed plane before descending over the edge of the feed plane onto the surface of the web in a curtain-like fashion. As shown in FIG. 6, several successive nozzle slits 21 make it possible to form a multilayer coating film on the feed plane 22, in that the coat layers are kept well separated from one another allowing for several successive coating layers to be applied simultaneously on the web.

The surface of the material web 7 to be coated has a layer of air moving along with the web 7. The air boundary layer hinders the application of the coating material on the web, which is why it is removed by the scraper 3 arranged in the direction of motion of the web 7 before the point where the coating material curtain 6 descends onto the web. The scraper 3 has a scraper surface 11 which faces the web in order to remove the air layer on the surface of the web 7. The scraper surface 11 of the scraper 3 should be positioned as close as possible to the point of impact of the coating material curtain 6, since a new air layer forms on the surface of the web 7 at a distance of as little as 50 mm or so. Typically, the scraper surface 11 of the scraper 3 is 5-75 mm, preferably 15-20 mm, away from the point where the coating material curtain 6 descends on the web 7.

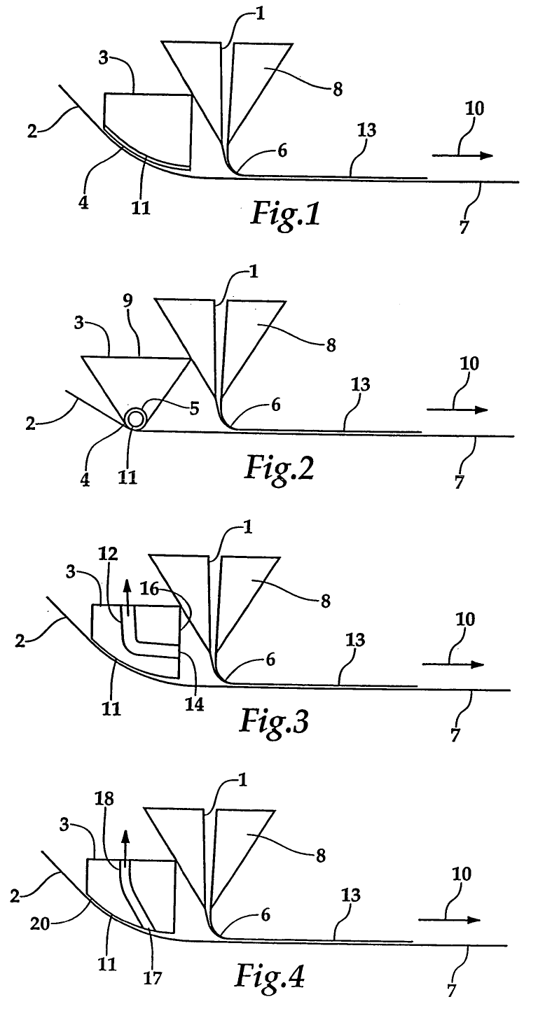

In FIG. 1, a scraper 3 is arranged before the coating material curtain, its convex scraper surface 11 extending over the whole width of the web 7 and removing the air boundary layer along the surface of the web 7. The scraper 3 and its scraper surface 11 are typically made of steel. A layer of air usually forms between the moving web 7 and the scraper surface, its thickness being influenced by the speed of the web 7 and the curvature radius of the scraper surface, among other things. Generally, the thickness of the air layer between the web 2 and the scraper surface is about 0-500 μm. The curved scraper surface 11 may also be used to guide the web.

The scraper 3 shown in FIG. 2 comprises a scraper rod 5 rotatably mounted on the body part 9 and facing the web surface in order to remove the air boundary layer on the surface of the web 7. The scraper rod 5 extends over the whole width of the web 7. The scraper rod 5 is typically made of steel.

In the embodiments shown in the drawings, the moving web 7 contacts the scraper surface 11 of the scraper 3, whereby the scraper surface quickly deteriorates at this point of contact. In order to improve durability, the scraper surface is surface-hardened or coated with a durability-enhancing coating layer. In the embodiment shown in FIG. 1, the scraper surface 11 of the convex scraper 3 is either surface-hardened or coated, as is the envelope surface of the scraper rod 5 in the embodiment shown in FIG. 2.

In contrast to the arrangement of FIG. 1, the embodiment shown in FIG. 3 has the scraper 3 complemented with a suction channel 12 extending over the cross-machine width of the web 2 and having its inlet opening 14 located at the downstream part 16 of the scraper 3. In this fashion, the boundary air layer traveling on the surface of the moving web 2 can be sucked into the suction channel 12.

In FIG. 4 is shown an arrangement wherein an inlet opening 17 of a suction channel 18 is adapted on the curved surface 20 of the scraper 3 facing the web 2.

The surface receiving the surface-hardening treatment is heated, e.g. inductively or by gas, for a period long enough to raise the temperature of the surface to the austenite temperature e.g., slightly above 700° C., and then waiting for the structure to homogenize. Only the scraper surface is heated to the austenite temperature. Following heating, the scraper surface 11 is quickly cooled or quenched, e.g. with water or oil, thereby turning the surface into hard martensite, after which various heat treatments may be performed on the surface in order to obtain the desired properties. Typically, the scraper surface 11 is tempered or reheated to a temperature of 150-200° C. and tempered at this temperature for a few hours, and then allowing the surface to cool slowly. The tempering temperature may be higher than mentioned above, however, this means that the surface hardness will begin to decrease. The result of this surface hardening is that the hardness of the scraper surface of the scraper facing the web is increased, while retaining its internal properties. The hardness of the surface-hardened scraper surface is approximately 900 Vickers hardness (HV).

The durability-enhancing materials which are coated on the scraper surface may be such materials as chromium or ceramic materials.

Chromium coating is done by, e.g. immersing the scraper surface in molten chromium, making the coating material adhere to the scraper surface, whereby it solidifies into a surface layer upon lifting the scraper surface out of the melt. A chromium coating may also be created through spraying, whereby the molten chromium surface material is sprayed onto the scraper surface, or through electrochemical coating methods. The hardness of the chromium coat is approximately 1000-1200 HV.

The ceramic coating layer is obtained by evaporating metals in the existing scraper surface, e.g. by using methods based on a chemical reaction (CVD. Chemical Vapour Deposition) or physical methods (PVD, Physical Vapour Deposition). In chemical evaporation coating, coating is done at a reduced pressure and by using a reactive gas at a temperature of about 800-1000° C.

In physical evaporation coating, the coating atoms are activated physically through vaporization or ion bombardment. As treatment method may be used, e.g. vacuum coating, whereby coating occurs in vacuum or a low-pressure chamber, in which the coating material is obtained in the gas phase. The coating material is usually evaporated with an electronic jet or through resistive heating. The coating material in the gas phase adheres to the surface of the piece to be coated. Optionally, coating may be performed at a raised temperature of about 400-500° C. Vacuum coating is also suitable for chromium coating. Other evaporation coating methods are, e.g. sputtering and ion coating. The hardness of a ceramic coating layer is typically 2000-5000 HV.

Typically, the thickness of a coating layer 4 to be formed on the scraper surface is 1 μm to 2 μm.

It should be noted that the scraper can be comprised of multiple pieces or areas positioned in the web running direction. As the scraper 3 has a surface with adjoining areas of different curvatures, the surface of a scraper can be made to have different areas or pieces. Moreover, the hardness of the scraper surface may vary in the machine direction, or in the cross-machine direction, for example by using different materials. The surface of the scraper can be made of multiple pieces in the machine direction. Moreover, the scraper may be provided with grooves extending in the cross direction or in the machine direction.

The scraper may also be provided with a cooling system, such as water circulation within the scraper. In addition, suction or an air blow may be used to remove paper dust. The suction or air blow for paper dust removal may be provided before the scraper, within the scraper, such as through the channels, 12 or 18, or could be after the scraper.

It is understood that the invention is not limited to the particular construction and arrangement of parts herein illustrated and described, but embraces all such modified forms thereof as come within the scope of the following claims.

We claim:

1. A curtain coater for coating a moving material web with coating material, of the type in which an application device is arranged above a material web having an upper surface, the web mounted for motion with respect to the curtain coater, the web arranged so that a coating material feeds onto the surface of the web in a curtain-like flow; and a scraper having a scraper surface placed against the web upper surface so as to remove an air boundary layer on the surface of the web; wherein the improvement comprises the scraper surface of the scraper placed against the web being surface-hardened or being provided with a durability-enhancing coating layer.

2. The curtain coater of claim 1, wherein the surface of the scraper placed against the web is coated with a coating layer comprising a ceramic material.

3. The curtain coater of claim 1, wherein the surface of the scraper placed against the web is coated with a coating layer of chromium.

4. The curtain coater of claim 1, wherein the surface of the scraper placed against the web is coated with a coating layer of a thickness of 1 μm to 2 mm.

5. The curtain coater of claim 1, wherein the surface of the scraper has a Vickers hardness (HV) of at least about 900 to 5000.

6. The curtain coater of claim 1, wherein the surface of the scraper has a Vickers hardness (HV) of at least about 1000 to 5000.

7. The curtain coater of claim 1, wherein the surface of the scraper has a Vickers hardness (HV) of at least about 2000 to 5000.

8. The curtain coater of claim 1, wherein the scraper surface of the scraper is an envelope surface of a scraper rod rotatably mounted on the scraper.

9. The curtain coater of claim 1, wherein the curtain coater is of the multilayer type and wherein the applicator nozzle is composed of a plurality of cross machine direction slits one above the other.

10. A curtain coater for coating an upper surface of a moving web of paper or board, the moving web defining a travel direction of the web, the curtain coater of the type in which an applicator nozzle is positioned above the web to be coated and configured so as to apply coating mix ejected therefrom to an upper surface of the web in a continuous curtain extending uniformly over a cross-machine width of the web; and a scraper having a scraper surface which is placed against the web upper surface configured to remove a boundary air layer traveling on the surface of the web to be coated, and the scraper being located upstream in the travel direction of the web of an impingement point of the coating mix curtain on the surface of the web and being located on the upper side of the web, the scraper having a scraper surface facing the web, the scraper surface being curved to support the web; wherein the improvement comprises: the scraper surface of the scraper which engages against the web having a surface-hardness of Vickers hardness (HV) of about 900 to 5000.

11. The curtain coater of claim 10 wherein the scraper surface which engages against the web comprises a coating layer formed on the scraper of about 1 μm to 2 mm in thickness.

12. The curtain coater of claim 11, wherein the surface of the scraper placed against the web is coated with a coating layer comprising a ceramic material.

13. The curtain coater of claim 10, wherein the surface of the scraper placed against the web is coated with a coating layer of chromium.

14. The curtain coater of claim 10, wherein the surface of the scraper placed against the web is coated with a coating layer of a thickness of 1 μm to 2 mm.

15. The curtain coater of claim 10, wherein the surface of the scraper has a Vickers hardness (HV) of at least about 1000 to 5000.

16. The curtain coater of claim 10, wherein the surface of the scraper has a Vickers hardness (HV) of at least about 2000 to 5000.

17. The curtain coater of claim 10, wherein the scraper surface of the scraper is an envelope surface of a scraper rod rotatably mounted on the scraper.

18. The curtain coater of claim 10, wherein the curtain coater is of the multilayer type and wherein the applicator nozzle is composed of a plurality of cross machine direction slits one above the other.

19. The curtain coater of claim 10 wherein said scraper comprises a suction nozzle extending over the cross-machine width of the web and set in the scraper so as to remove by suction the boundary air layer traveling on the surface of the web

20. A method of coating an upper surface of a moving web of paper or board, the method comprising the steps of:
applying a coating mix by ejecting from a coater, which has an applicator nozzle positioned above the web, a continuous curtain of coating mix on to an upper surface of the web at an impingement position, the continuous curtain extending uniformly over a cross-machine width
before coating the web, removing a boundary air layer traveling on the surface of the web with a scraper having a scraper surface which is positioned against the web upper surface, the scraper being iocated upstream in the travel direction of the web of the impingement position of the coating mix curtain on to the upper surface of the web;
supporting the web with a curved scraper surface facing the web; and
reducing wear of the scraper surface of the scraper which engages against the web, by increasing the scraper surface to a surface-hardness of Vickers hardness (HV) of about 900 to 5000.

21. The method of claim 20, further comprising the step of using a suction nozzle extending over the cross-machine width of the web forming a part of the scraper so as to remove by suction a boundary air layer traveling on the surface of the web, wherein the surface of the scraper is increased to a surface-hardness of Vickers hardness (HV) of at least about 2000 to 5000.
